(19) United States
(12) Patent Application Publication
(10) Pub. No.: US 2006/0127632 A1
(43) Pub. Date: Jun. 15, 2006

(54) Corner rug

(76) Inventor: Shelley Pelky, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 11/013,254

(22) Filed: Dec. 14, 2004

(51) Int. Cl. B32B 3/02; B32B 33/00; D05C 17/02

(52) U.S. Cl. 428/85; 428/99; 428/95

(57) ABSTRACT

An L-shaped rug that fits in a hallway corner. The rug traps dirt so that substantially no dirt reaches the underlying floor or material. The rug is easily removed and cleaned.

### BACKGROUND

This invention relates generally to floor coverings and more specifically to a rug made for corners of halls.

Hallways are one of the most traveled portions of a building, so they tend to collect the most dirt. Unfortunately, however, hallways are particularly difficult to clean because there is limited space in which to maneuver a broom, vacuum or mop. The residue left at the intersection of the walls is nearly impossible to remove because standard floor cleaning devices cannot get into the corner. Particularly avid cleaning people may use small devices such as toothbrushes to clean crevices in the corner, but that is time-consuming and inefficient. It would be desirable to have clean hallway corners.

Therefore, it is an object of this invention to provide an apparatus that makes it easier to have clean corners in hallways.

### SUMMARY OF THE INVENTION

The present invention is device for making it easier to have clean corners in hallways. The device is an L-shaped rug that fits in a hallway corner. The rug traps dirt so that substantially no dirt reaches the underlying floor or material. The rug is easily removed and cleaned.

### BRIEF DESCRIPTION OF THE FIGURES

FIG. 1 is a perspective view of a hallway showing the present invention.

FIG. 2 is a top view of the present invention in a first configuration.

FIG. 3 is a top view of the present invention in a second configuration.

FIGS. 4a, b and c illustrate how pieces may be combined to form the invention.

FIG. 5 is a bottom view of the present invention showing a first means for attachment to the floor.

FIG. 6 is a bottom view of the present invention showing a second means for attachment to the floor.

FIG. 7 is a perspective view of a hallway showing the preferred embodiment present invention installed snugly between the hallway walls.

FIG. 8a is a cross-section of the rug in the cut pile material.

FIG. 8b is a cross-section of the rug in the loop pile material.

### DETAILED DESCRIPTION OF THE INVENTION

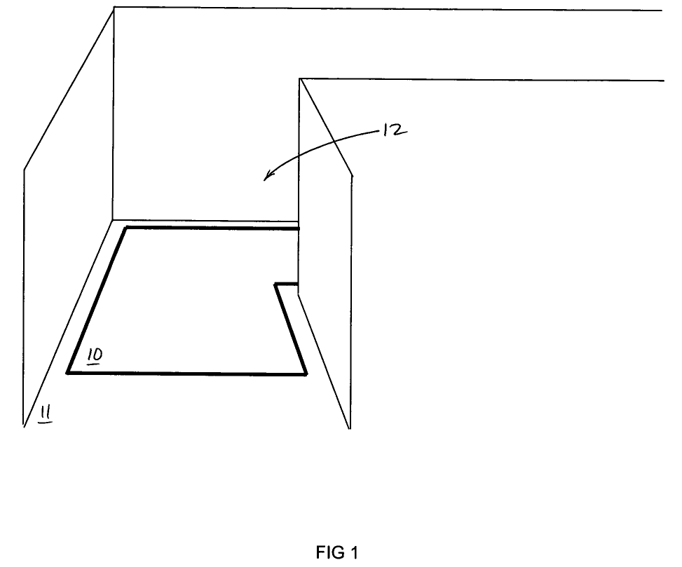

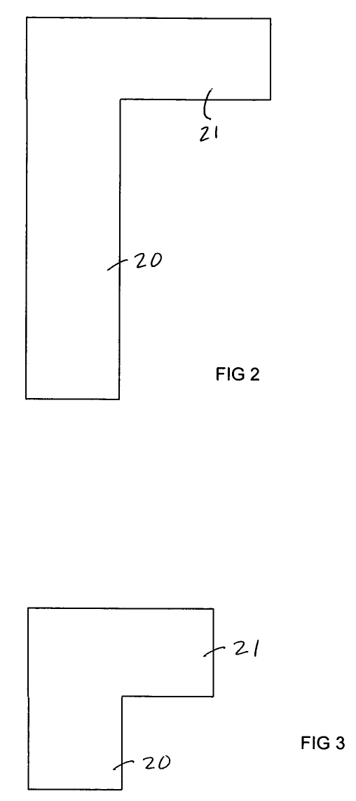

The present invention is an L-shaped rug that traps dirt and prevents it from FIG. 1 shows the rug 10 installed on the floor 11 of a hallway 12. The rug 10 comprises a first arm 20 at substantially a right angle to a second arm 21. The length of the arms is determined by the configuration of the hallway and the appearance desired by the user. FIG. 2 shows the preferred embodiment in which the first arm 20 and second arm 21 are of different lengths. FIG. 3 shows the first arm 20 having the same length as the second arm 21.

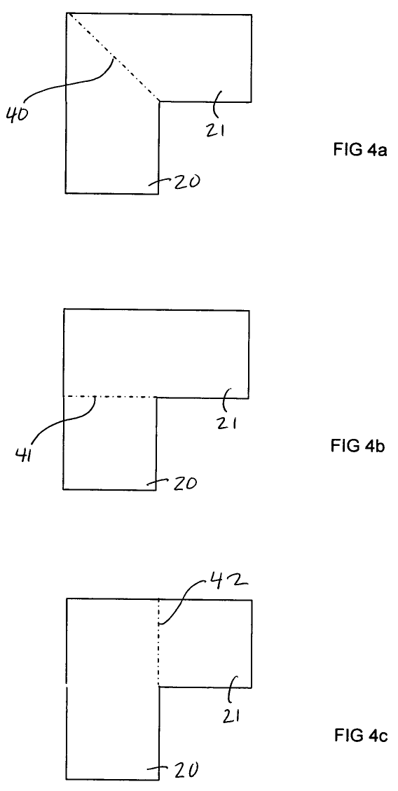

In the preferred embodiment, the rug is a single piece, with the first arm 20 integral with the second arm 21. See FIGS. 2 and 3. It may be desirable, however, to make the rug 10 from separate pieces. FIG. 4 shows several ways to accomplish this, whether the adjoining edges are indicated by dashed lines. For example, in FIG. 4a, the first arm 20 and second arm 21 are joined along the line connecting the corners 40. In FIG. 4b the end of the first arm 20 is joined to second arm 21 along the edge 41 of the second arm 21. In FIG. 4c the end of the second arm 21 is joined to first arm 20 along the edge 42 of the first arm.

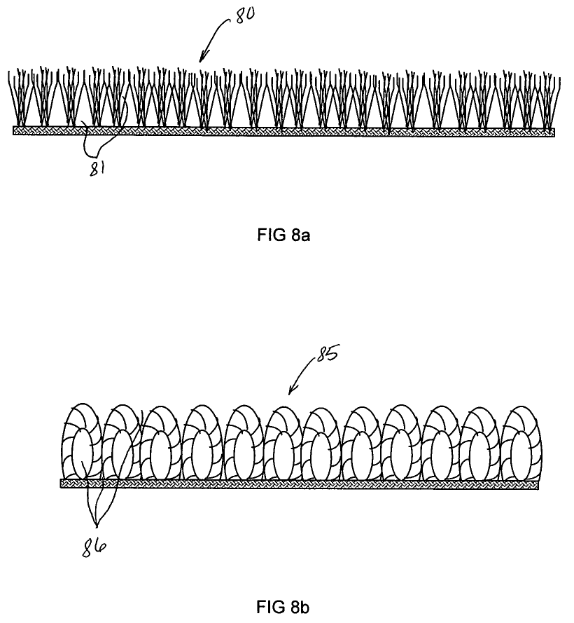

The rug 10 is removable from the hallway so that it can be easily cleaned. Preferably the rug is easily cleaned by means of, for example, vacuuming, washing, or shaking. The rug 10 can be made of any material suitable for rugs, including woven fibers such as silk, wool, cotton, nylon, polyester, or polyethylene; or non-woven materials such as rubber or plastic. Preferably the rug has fibers, natural or synthetic, that have interstitial spaces to trap dirt, such as cut or loop pile. FIG. 8a shows cut pile 80 with interstitial spaces 81 and FIG. 8b shows loop pile 85 with interstitial spaces 86.

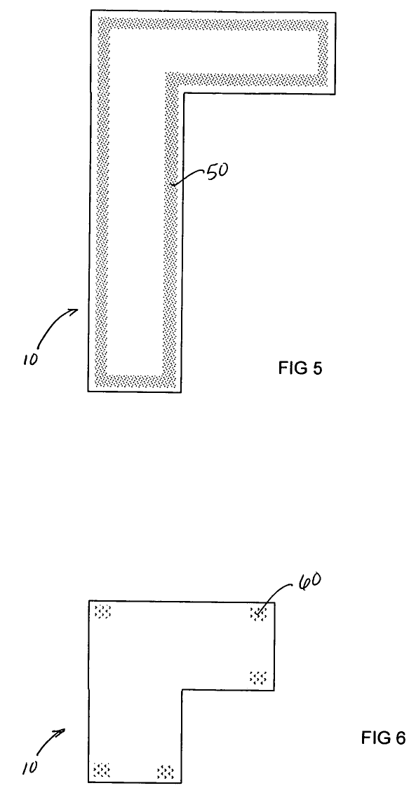

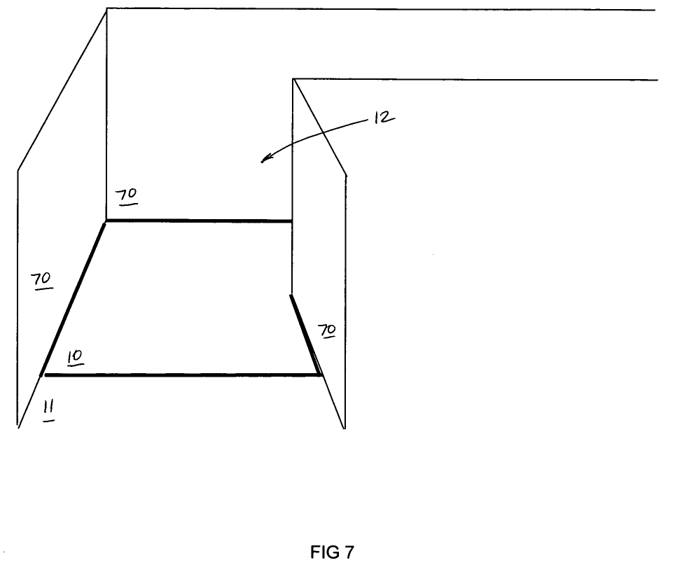

To prevent the rug from inadvertently moving out of place or slipping on the floor in the hallway, the rug 10 may be attached to the floor 11 of the hallway 12 using a variety of means for removeably attaching the rug. To attach the rug to a hardwood, tile, or cement floor, for example, the attachment means can be adhesive. FIG. 5 shows the bottom of the rug 10 with adhesive 50 on all or a portion of its periphery. The means for attachment may also be rubber or plastic that does not easily slide on hard floors. In the event the floor of the hallway has carpet, the rug can be laid over the carpet. In such case, the rug may be equipped with means for attachment that hook into the carpet. FIG. 6 shows a rug 10 with means for attaching the rug to carpet 60 made of the hooked portion of the hook-and-loop device known as VELCRO®. In the preferred embodiment, however, the rug 10 fits snugly between the walls 70 of the hallway so that it does not shift when walked on or vacuumed. See FIG. 7.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A device for making it easier to have clean corners in hallways having a floor comprising an L-shaped rug.

2. The device of claim 1 in which the rug is not attached to the floor.

3. The device of claim 1 in which the rug is comprised of a material that traps dirt.

4. The device of claim 3 in which the material is cut pile.

5. The device of claim 3 in which the material is loop pile.

6. The device of claim 1 in which the rug further comprises:
a) a top side and a bottom side; and
b) means for removeably attaching the rug to the floor.

7. The device of claim 6 in which the floor is carpet.

8. The device of claim 6 in which the floor is tile.

9. The device of claim 6 in which the floor is wood.

10. The device of claim 6 in which the floor is concrete.

11. The device of claim 6 in which the means for removeably attaching the rug is adhesive.

12. The device of claim 6 in which the means for removeably attaching the rug is the hook portion of VELCRO®.

13. The device of claim 6 in which the means for removeably attaching the rug is rubber.

14. The device of claim 1 in which the L-shaped rug further comprises a first arm at a substantially right angle to a second arm.

15. The device of claim 14 in which the first arm is shorter than the second arm.

16. The device of claim 14 in which the first arm is the same length as the second arm.

17. The device of claim 14 in which the first arm and second arm are integral.

18. The device of claim 14 in which the first arm and second arm are attached to form the right angle.
